(19) United States
(12) Patent Application Publication
(10) Pub. No.: US 2019/0258759 A1
(43) Pub. Date: Aug. 22, 2019

(54) TOTAL INTEGRATION ANALYSIS MODEL ASSISTANCE DEVICE

(71) Applicant: HITACHI, LTD., Tokyo (JP)

(72) Inventors: Norihiko Nonaka, Tokyo (JP); Masayuki Kaiho, Tokyo (JP)

(73) Assignee: HITACHI, LTD., Tokyo (JP)

(21) Appl. No.: 16/315,703

(22) PCT Filed: Jul. 4, 2017
(86) PCT No.: PCT/JP2017/024424

§ 371 Date: Jan. 7, 2019

(30) Foreign Application Priority Data
Aug. 8, 2016 (JP) 2016-155187

(51) Int. Cl. G06F 17/50; G06Q 50/04; G06Q 10/06

(52) U.S. Cl. CPC G06F 17/5009; G06Q 50/04; G06F 2217/12; G06Q 10/067; G06F 2217/16; G06Q 10/06315

(57) ABSTRACT

Aiming at improved analysis accuracy and shortened time for analysis, a total integration analysis device is provided for simultaneously estimating a performance and a manufacturing cost of a mechanical structure. The device includes means for displaying an analysis process input screen, means for displaying an analysis condition input screen on which an input condition required for the analysis is displayed, means for creating an analysis model in accordance with the analysis process to analyze a performance estimation, and analyzing the manufacturing cost in accordance with a result of the performance estimation, means for acquiring past manufacturing cost information, means for displaying a data analysis condition input screen on which an analysis condition is displayed, means for grouping the past manufacturing cost information using a clustering method, means for visualizing a result derived from the unit for grouping as a graph, and means for acquiring and displaying an analysis result.

### TECHNICAL FIELD

The present invention relates to a total integration analysis model assistance device.

### BACKGROUND ART

The background art of the relevant technical field is disclosed in Japanese Unexamined Patent Application Publication No. 2002-259888 (Patent Literature 1). The abstract of Patent Literature 1 is described as below. “The model selection unit selects the simulation model based on the selection condition set by the condition input unit so as to read the selected simulation model from the model database. Using the read simulation model, the simulation calculation unit executes the simulation calculation based on the initial state set by the condition input unit, and the simulation condition. Based on the model selection condition, the simulation calculation is executed by selecting the simulation model from those with different levels of details. For example, the highly accurate simulation will be executed for the important part using the model with high level of details, and the simulation will be executed for the other part with less importance in a short time using the model with low level of details.”

The background art of the relevant technical field is disclosed in Japanese Unexamined Patent Application Publication No. 2015-90639 (Patent Literature 2). The abstract of Patent Literature 2 is described as below. “The control unit equalizes the power consumption information every 30 minutes for each category so as to create each average power consumption pattern in daytime and nighttime of the day. The control unit then derives the correlation between the temperature and the power consumption for each category from the temperature information and the power consumption information of each day. Under the circumstance, in the case of the daytime, the correlation between the highest temperature and the total power consumption in the daytime is obtained. In the case of the nighttime, the correlation between the lowest temperature and the total power consumption in the nighttime is obtained. Then estimated temperatures (estimated highest temperature and estimated lowest temperature) of the day are acquired via the network. In accordance with the category of the day, the estimated power consumption in the daytime or the nighttime corresponding to the acquired estimated temperature is obtained.”

### CITATION LIST

### Patent Literature

Patent Literature 1: Japanese Unexamined Patent Application Publication No. 2002-259888

Patent Literature 2: Japanese Unexamined Patent Application Publication No. 2015-90639

### SUMMARY OF INVENTION

### Technical Problem

The generally employed analysis has been proposed to execute the analysis calculation for simulation with high accuracy of the important part using the model with high level of details, and for simulation with low accuracy of the other less important part using the model with low level of details by using the single unit of the analysis model, or selecting one of analysis models in accordance with the analysis condition. The analysis calculation is intended to estimate the stress generated in the mechanical structure to be analyzed, and the performance such as efficiency. In the above-described circumstances, calculation of the manufacturing cost of the mechanical structure may be largely influenced by the method or procedure of processing the mechanical structure. Therefore, it is difficult for the generally employed analysis method to calculate such manufacturing cost. Execution of the analysis individually while taking into account of the respective processing methods may cause the problem of prolonging the calculation time.

In the case of Patent Literature 1, the method of calculating the manufacturing cost is not sufficiently considered.

The calculation method for estimating the cost or the like based on the past data is implemented by generating the correlation (continuous) function while setting the cost required to be estimated as the dependent variable, and the temperature or the like as the independent variable. The calculation of the manufacturing cost of the mechanical structure may be largely influenced by the method or procedure of processing the mechanical structure. Individual consideration of the “process method 1”, “process method 2” and the like in the discrete manner may cause difficulties in applying the task to the continuous function. Even if the correlation function is made forcibly, the resultant estimation may exhibit low accuracy.

In the case of Patent Literature 2, estimation in the discontinuous situation is not sufficiently considered.

### Solution to Problem

In order to solve the above-described problem of the related art, the present invention provides a total integration analysis model assistance device which simultaneously estimates a performance and a manufacturing cost of a mechanical structure to be analyzed. The device includes means for displaying an analysis process input screen on which an analysis process is displayed by selecting an analysis node having an analysis program, means for displaying an analysis condition input screen on which an input condition required for the analysis is displayed, means for creating an analysis model in accordance with the analysis process to analyze a performance estimation, and analyzing the manufacturing cost in accordance with a result of the performance estimation, means for acquiring past manufacturing cost information, means for displaying a data analysis condition input screen on which an analysis condition is displayed, means for grouping the past manufacturing cost information using a clustering method, means for visualizing a result derived from the unit for grouping as a graph, and means for acquiring and displaying an analysis result.

### Advantageous Effects of Invention

The present invention ensures to improve the analysis accuracy, and shorten the analysis time.

### BRIEF DESCRIPTION OF DRAWINGS

FIG. 1 is a view of an overall structure according to an example of the present invention.

FIG. 2 is a view representing a process procedure (Phase 1) according to an example of the present invention.

FIG. 3 is a view representing process procedures (Phase 2 and Phase 3) according to the example of the present invention.

FIG. 4 is a view of an analysis process defining screen according to an example of the present invention.

FIG. 5 is a view of an analysis condition input screen according to an example of the present invention.

FIG. 6 is a view of a data analysis condition input screen according to an example of the present invention.

FIG. 7 is a view of a data analysis result screen according to an example of the present invention.

FIG. 8 is a view of an analysis result display screen according to an example of the present invention.

### DESCRIPTION OF EMBODIMENT

This example relates to a computer-aided analysis assistance device by integrally calculating both the efficiency performance and the manufacturing cost of the mechanical structure. The example will be described referring to the drawings.

### First Example

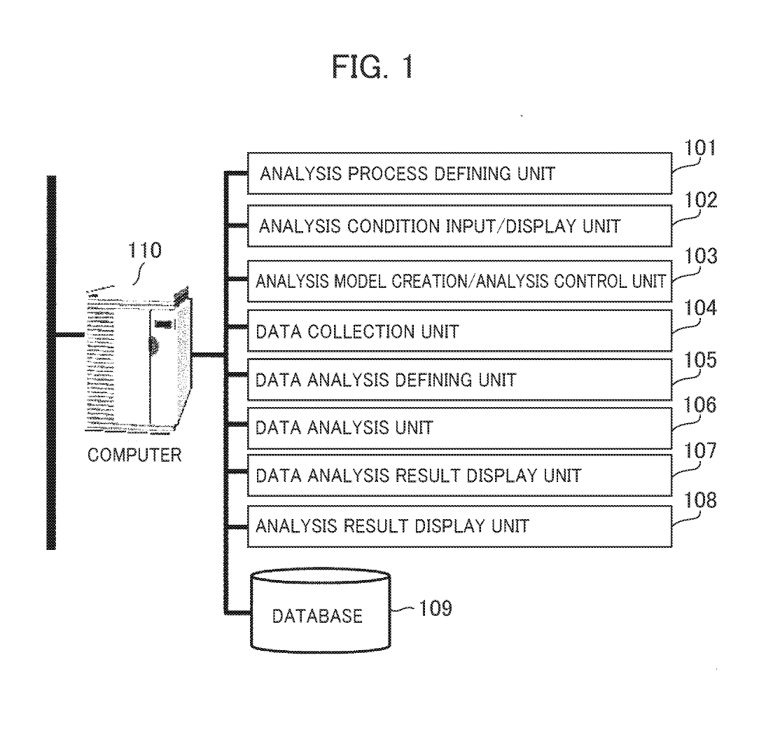

FIG. 1 is a view of an overall structure according to an example of the present invention. The device according to the example as shown in FIG. 1 includes an analysis process defining unit 101, an analysis condition input/display unit 102, an analysis model creation/analysis control unit 103, a data collection unit 104, a data analysis defining unit 105, a data analysis unit 106, a data analysis result display unit 107, an analysis result display unit 108, a database 109, and a computer 110. The structure of the device is not limited only to the one as described above. It is possible to partially delete or replace the structure, or add the other structure so long as the resultant structure does not deviate from the scope of the example.

The analysis process defining unit 101 displays an analysis process input screen through which an operator inputs an analysis process through drag and drop of an analysis model name and an analysis node containing the analysis program (synonymously, simply selecting the analysis node). The input analysis process information is displayed and further input to the database 109.

The analysis condition input/display unit 102 displays an analysis condition input screen through which the operator inputs the input condition required for analyzing the analysis model input by the analysis process defining unit 101. The input analysis condition information is displayed on the input screen, and further input to the database 109.

The analysis model creation/analysis control unit 103 acquires information data input through the analysis process defining unit 101, the analysis condition input/display unit 102, and the data analysis unit 106, and creates the analysis model in accordance with the analysis process so as to execute a performance estimation analysis. In accordance with the performance estimation result, the group corresponding to the group information generated by the data analysis unit is calculated, and the analysis is executed by obtaining the arithmetic mean value of the manufacturing cost data of the corresponding group as the manufacturing cost. Upon completion of the analysis, the analysis result is input to the database 109.

The data collection unit 104 acquires the past manufacturing cost information from the database 109.

The data analysis defining unit 105 displays a data analysis condition input screen through which the operator selects variables for the X-axis and the Y-axis, respectively for plotting on the graph. The variance for the group is input, and the input data analysis condition information is displayed on the input screen. The input information is then input to the database 109.

The data analysis unit 106 divides the past manufacturing cost information into groups that coincide with the input variance using the k-means clustering method in accordance with the condition input by the data analysis defining unit 105. The result is then input to the database 109.

The data analysis result display unit 107 displays the result of grouping calculated by the data analysis unit 106 for the operator in the form of the graph.

The analysis result display unit 108 acquires the result of analysis executed by the analysis model creation/analysis control unit 103 from the database 109 so as to be displayed for the operator.

The database 109 stores data derived from the analysis model input/display unit 101, the analysis condition input/display unit 102, the analysis model creation/analysis control unit 103, the data collection unit 104, the data analysis defining unit 105, the data analysis unit 106, the data analysis result display unit 107, and the analysis result display unit 108.

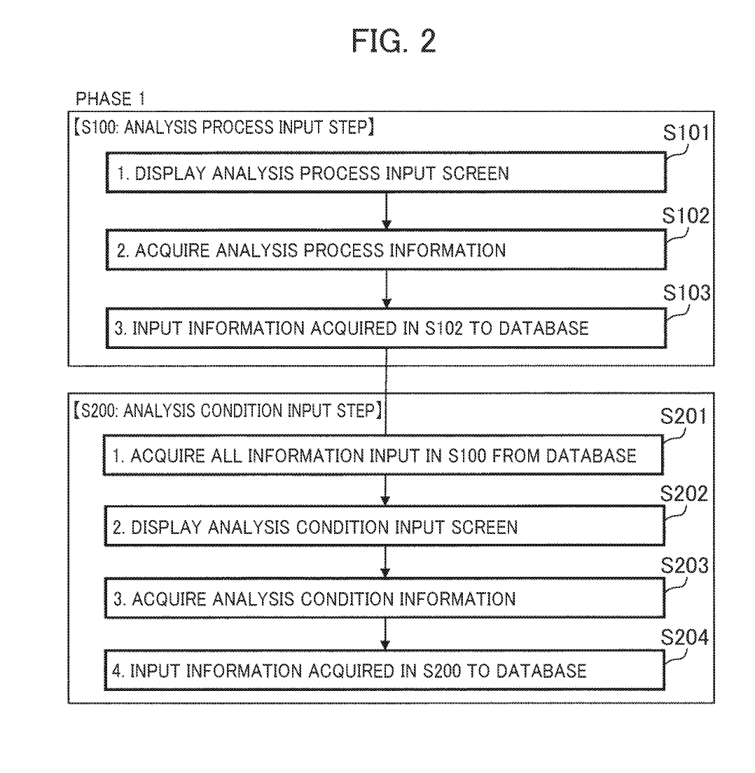

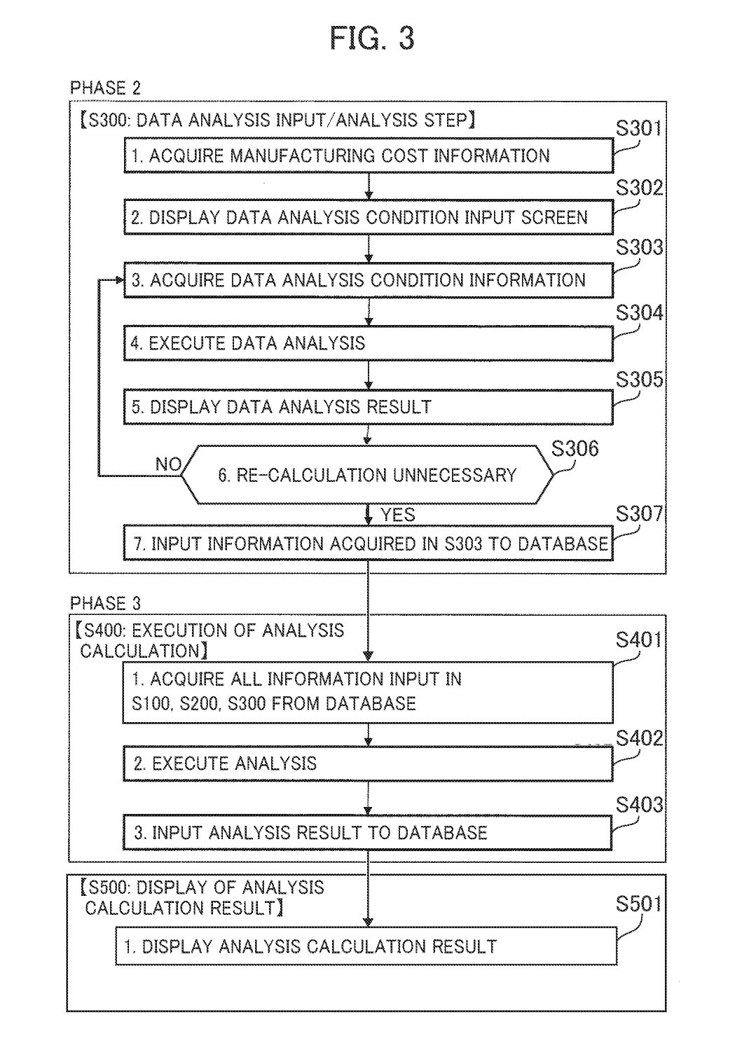

The above-configured process steps according to the embodiment will be described referring to FIGS. 2 to 8. FIG. 2 is a view representing the process steps (Phase 1) according to the example of the present invention. FIG. 3 is a view representing the process steps (Phase 2, Phase 3) according to the example of the present invention. Specifically, FIGS. 2 and 3 are flowcharts representing the process steps executed in the total integration analysis device as shown in FIG. 1. The process steps according to the example are generally divided into three phases. In the first phase, the analysis process is input, and a condition for the analysis is input. In the second phase, the data analysis is input and executed. In the third phase, the analysis calculation is executed, and the analysis result is displayed.

Taking a centrifugal compressor as an example of the mechanical structure, the means of the total integration analysis for estimating the performance and the manufacturing cost will be described referring first to Phase 1. The centrifugal compressor is the machine configured to rotate the impeller for suction of a gas, and to gradually reduce the gas flow rate in the centrifugal direction for compression. The centrifugal compressor includes a plurality of impellers for gas compression. Taking the compressor as the example, the means for integrally analyzing the performance and the manufacturing cost of the compressor will be described.

In S100 of Phase 1 as shown in FIG. 2, the analysis process defining unit 101 inputs the analysis process.

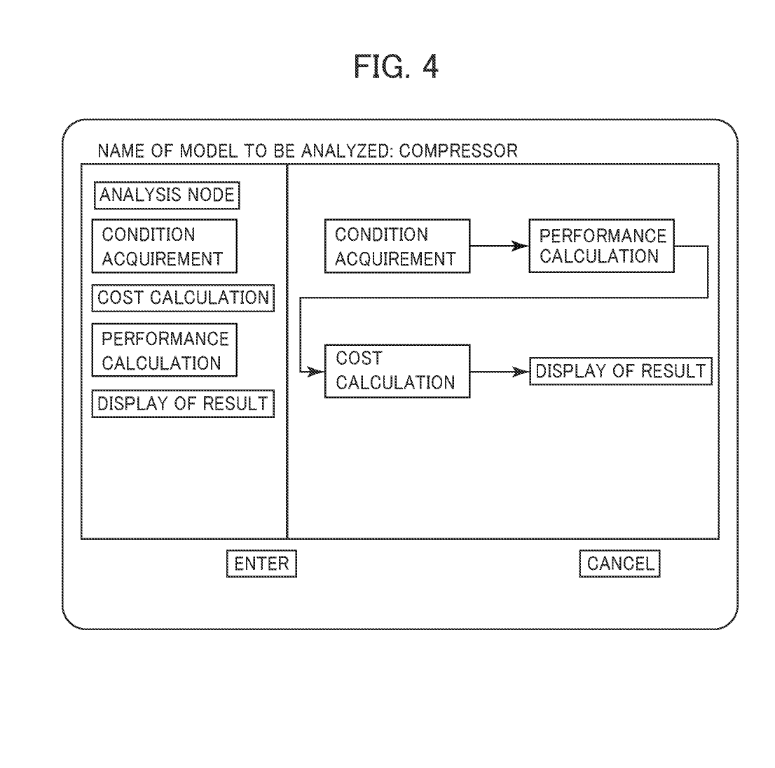

In S101, the analysis process defining unit 101 displays the analysis process input screen. FIG. 4 shows an example of the input screen. FIG. 4 is a view representing the analysis process defining screen according to the example of the present invention. The operator inputs the analysis process to be executed subsequently. Referring to the drawing, the compressor is input as the analysis model. On the left section of the exemplified screen, blocks called analysis node, each containing the program are displayed. The block “condition acquirement”, for example, contains the program which acquires the condition for analysis so as to be executed. In this case, such block will be called the analysis node. The “performance calculation” contains the program which estimates the performance of the compressor. The “cost calculation” contains the program which estimates the manufacturing cost of the compressor. The “result display” contains the program which displays the calculation result. The operator drags and drops the analysis node displayed on the analysis node onto the right section of the screen for defining the analysis steps. In this case, the analysis node is input in the order of the “condition acquirement”, “performance estimation”, “cost calculation”, and “result display”.

In S102, the analysis process information which has been input in S101 is acquired, that is, “condition acquirement”, “performance estimation”, “cost calculation”, and “result display”.

In S103, the information obtained in S102 is acquired, and input to the database 109.

In S200 as shown in FIG. 2, the analysis condition input/display unit 102 inputs the analysis condition.

In S201, the information input by the analysis process defining unit 101 is acquired from the database 109.

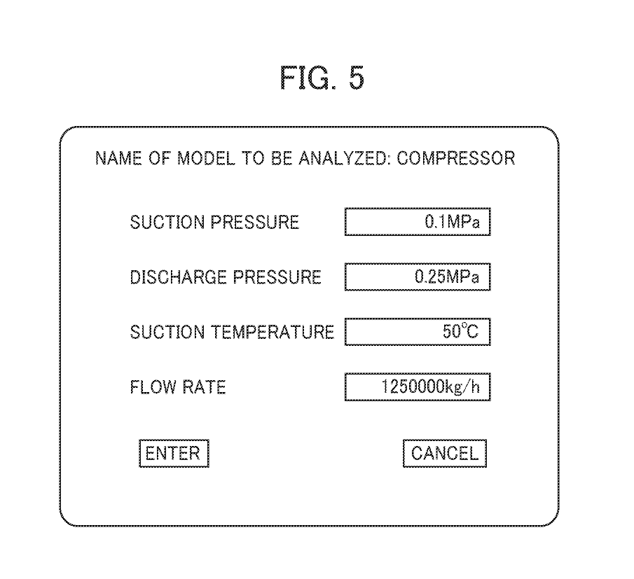

In S202, the analysis condition input/display unit 102 displays the analysis condition input screen. FIG. 5 shows an example of the input screen. FIG. 5 is a view representing the analysis condition input screen according to the example of the present invention. The operator inputs the analysis condition for analysis. In this case, the compressor is input as the analysis model name. As the analysis conditions, the suction pressure is set to 0.1 MPa, the discharge pressure is set to 0.25 MPa, the suction temperature is set to 50° C., and the flow rate is set to 1250000 kg/h. The above-described analysis conditions are required for calculating the performance and the cost of the compressor.

In S203, the analysis conditions input in S202 are acquired.

In S204, the information obtained in S203 is acquired, and input to the database 109.

An explanation will be made with respect to Phase 2. In S300 as shown in FIG. 3, the data collection unit 104 acquires the past manufacturing cost information, and the data analysis defining unit 105 inputs the conditions required for the data analysis. The data analysis unit 106 executes the data analysis. The data analysis result display unit 107 displays the analysis result, and inputs the result to the database.

In S301, the data collection unit 104 acquires the past manufacturing cost information from the database 109. In this case, the manufacturing cost information of the compressor is acquired. The database 109 stores the manufacturing cost of the compressor which has been designed in the past, and the performance information such as the length of the compressor, the external diameter of the impeller, the efficiency, and the head for acquisition.

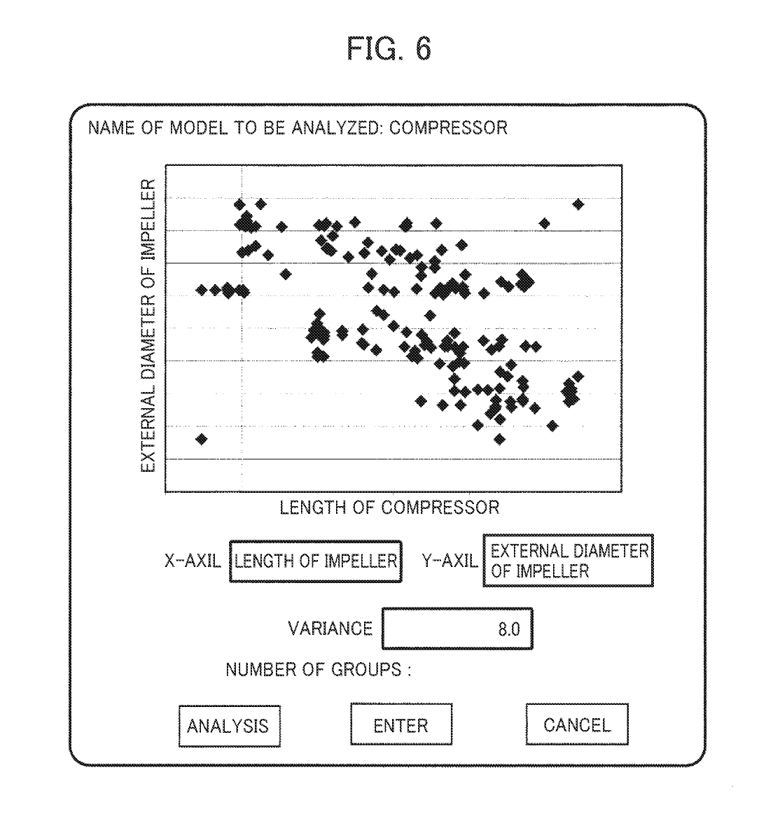

In S302, the data analysis defining unit 105 displays the data analysis input screen. FIG. 6 shows an example of the data analysis condition input screen. FIG. 6 is a view representing the data analysis condition input screen according to the example of the present invention. The operator inputs the conditions required for executing the data analysis. In this case, the compressor is displayed as the analysis model name. The graph on the screen displays the past manufacturing cost information. Variables for the X-axis and the Y-axis may be selectable for displaying the manufacturing cost information on the graph. In this case, the length of the compressor is selected for the X-axis, and the external diameter of the impeller is selected for the Y-axis. The graph on the display screen represents plotted past data having the compressor length selected for the X-axis, and the external diameter of the impeller selected for the Y-axis. Accordingly, the graph on the display screen represents the plotted past data having the compressor length selected for the X-axis, and the external diameter of the impeller selected for the Y-axis. It is possible to select the information registered in the database for the X-axis and the Y-axis, for example, the manufacturing cost, the efficiency, and the head. The variance for the data analysis is then input. In this case, 8.0 is input.

In S303, the information of the data analysis condition input in S302 is acquired.

In S304, the data analysis unit 106 executes the data analysis. In this case, the analysis is executed using the k-means clustering method. The analysis step using the k-means method will be described as follows.

1. Data xᵢ (i=1 . . . n) is randomly assigned to groups. The code n denotes the number of variables. As the values input corresponding to the X-axis and the Y-axis in S302 are variables, the code n is set to 2. The compressor length and the external diameter of the impeller are variables.
2. Based on the data assigned to the groups, the center Vⱼ (j=1 . . . k) of each group is calculated. The code k denotes the number of groups. The arithmetic mean of the data corresponding to the assigned group is used for calculating the Vⱼ.
3. Each distance between the Vⱼ and the data xᵢ is obtained so that the xᵢ is re-assigned to the group with the nearest center.
4. If the calculation result shows that assignment of groups to all the data xᵢ has not been changed, or the amount of the change is smaller than the preliminarily set threshold value, the process proceeds to the next step. In the case of the opposite result, the group is newly assigned, and recalculation is executed from the analysis step 2.
5. The variance of the distance between the xᵢ and Vⱼ is calculated. If the absolute value of the difference between the calculated variance and the one input in S302 is smaller than the preliminarily set threshold value, the process ends. If the calculated variance is larger than the input one, the number of the groups is increased. If the calculated variance is smaller than the input one, the number of the groups is decreased. The process then returns to the analysis step 1.

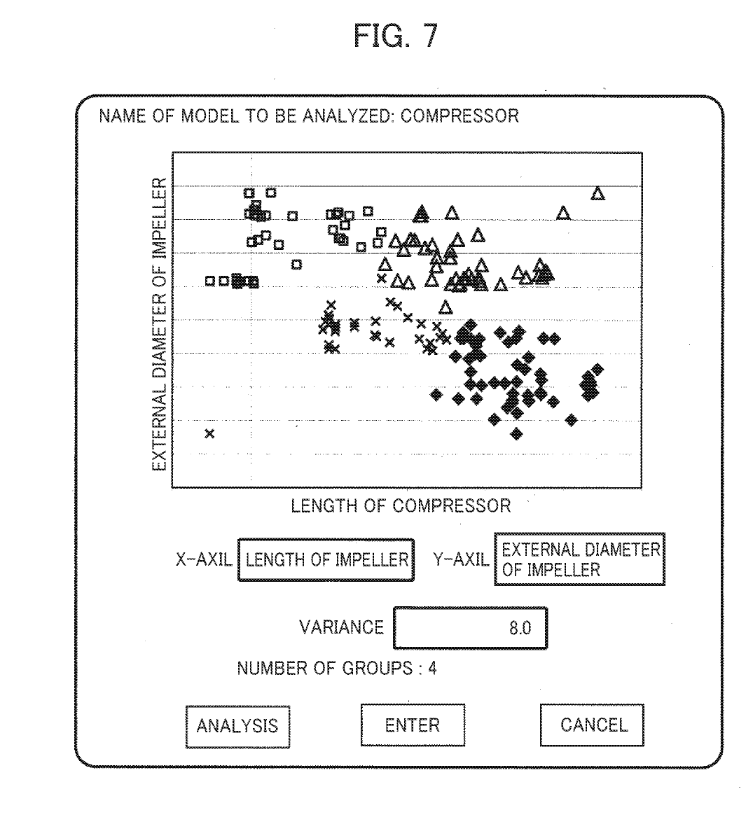

In S305, the data analysis result display unit 107 displays the analysis result. FIG. 7 shows an example of the data analysis result display screen. FIG. 7 is a view showing the data analysis result screen according to the example of the present invention. The number of groups is set to 4 as the analysis result. The four divided results are displayed on the graph as plotted groups marked with ♦, ▪, x, Δ.

In S306, referring to the result displayed in S305, if the operator requires increasing the number of groups, the variance is decreased. If the number of groups is required to be decreased, the variance is increased. Then the analysis button is pressed to return to S303. If the operator determines that the result is appropriate, Enter button is pressed.

In S307, the analysis result obtained in S304 is acquired, and input to the database 109.

Phase 3 will be described. In S400 as shown in FIG. 3, the analysis model creation/analysis control unit 103 acquires the information input in S100, S200, S300 to execute the analysis for estimating the performance and the manufacturing cost. In S500, the analysis result display unit 108 displays the analysis result.

In S401, the analysis model creation/analysis control unit 103 acquires the analysis process input in S100, the analysis conditions input in S200, and the group information input in S300.

In S402, the analysis model is created and analyzed. In this case, in accordance with the analysis process input in S100, the analysis model is created and analyzed. Firstly, the calculation conditions are acquired. The conditions such as the suction pressure, the discharge pressure, and the suction temperature are acquired. Then the performance calculation is executed. Using the input conditions, the compressor length, the external diameter of the impeller, the efficiency, and the head are calculated. Then the cost calculation is executed. In this case, the manufacturing cost is calculated using the compressor length and the external diameter of the impeller in reference to the group information analyzed in S300. In other words, using the compressor length and the external diameter of the impeller, which have been calculated in S402, the corresponding group is obtained. The arithmetic mean of the manufacturing cost of the corresponding group is set as the manufacturing cost.

In S403, the analysis result is input to the database 109. In this case, the compressor length, the external diameter of the impeller, the efficiency, the head, and the manufacturing cost are input to the database.

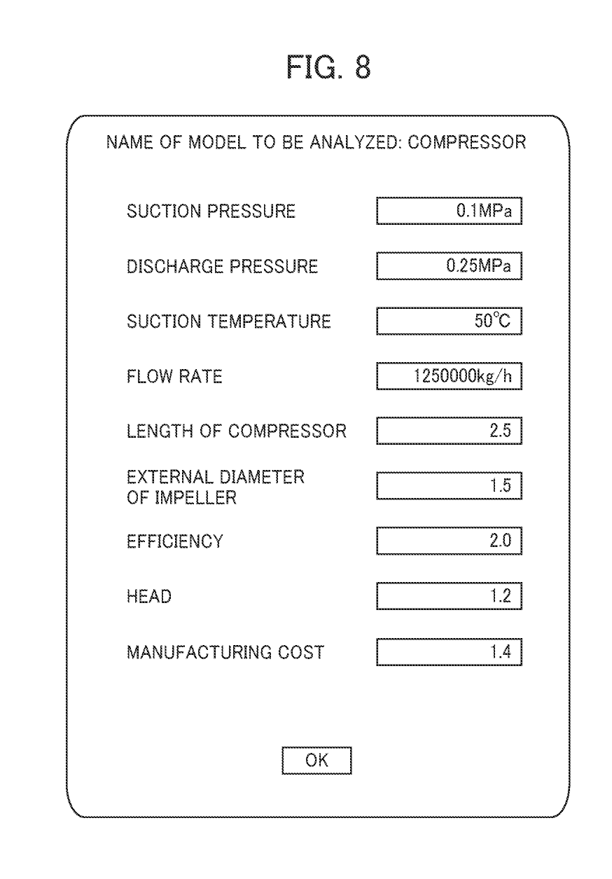

In S501, the analysis result display unit 108 displays the result of the total integration analysis which has been executed by the analysis model creation/analysis control unit 103. FIG. 8 shows an example of the analysis result display screen. FIG. 8 is a view showing the analysis result display screen according to the example of the present invention. Referring to the drawing, the suction pressure, the discharge pressure, the suction temperature, the flow rate as calculation conditions for the compressor are displayed. Further, the compressor length, the external diameter of the impeller, the efficiency, the head, the manufacturing cost as the analysis results are displayed, representing the values relative to those of the standard machine.

As described above, the information of the past manufacturing cost and the performance is collected for integrated calculation of the performance and the manufacturing cost of the mechanical structure. The collected data is then grouped through the clustering method. The results are stored in the database. This ensures to evaluate the performance of the mechanical structure, and simultaneously the creation cost in reference to the performance information derived from the group information to which the mechanical structure is corresponded. This makes it possible to shorten the estimation time.

The embodiment provides the total integration analysis device, and the method thereof. The device includes: means for displaying the analysis process input screen, inputs the analysis model name and the analysis process through the operator's operation for dragging and dropping the analysis node containing the analysis program, and displaying the input analysis process information; means for displaying the analysis condition input screen through which the operator inputs the input conditions required for analyzing the input analysis model, and displaying the input analysis condition information on the input screen; means for creating the analysis model in accordance with the analysis process for analyzing the performance estimation, calculating the group corresponding to the created group information in accordance with the performance estimation result, and executing the analysis by setting the arithmetic mean of the manufacturing cost data of the corresponding group as the manufacturing cost; means for acquiring the past manufacturing cost information; means for displaying the data analysis condition input screen through which the operator selects variables for the X-axis and the Y-axis to be plotted on the graph so as to be displayed, inputting the variance for grouping, and displaying the input data analysis condition information on the input screen; means for dividing the past manufacturing cost information into groups each corresponding to the input variance through the k-means clustering method; means for displaying the grouping result on the graph; and means for acquiring the analysis results and displaying the analysis results for the operator.

As described above, the past manufacturing cost data is grouped through the clustering method, and the grouping results are stored in the database. It is possible to evaluate the performance of the mechanical structure, and simultaneously, to estimate the manufacturing cost from the information of the group to which the mechanical structure is corresponded, thus shortening the time for estimation. The past manufacturing cost data is grouped through the clustering method, and the results are stored in the database for estimating the performance and calculating the manufacturing cost of the mechanical structure to be analyzed. The operator is allowed to analyze the performance of the mechanical structure for estimation, and simultaneously, to estimate the manufacturing cost, thus improving the analysis accuracy and shortening the time for analysis.

In this example, the grouping is executed based on the two-dimensional information including variables set for the X-axis and the Y-axis. However, the grouping process may be expanded to the use of the N-dimensional information.

The k-means clustering method is employed as described above. However, it is possible to employ any other clustering method such as the self-organizing mapping.

As described above, the analysis node constituting the analysis process is analyzed using the same computer. However, it is possible to use another computer in addition to the one as described above utilizing the network environment.

### LIST OF REFERENCE SIGNS

101: analysis process defining unit,
102: analysis condition input/display unit,
103: analysis model creation/analysis control unit,
104: data collection unit,
105: data analysis defining unit,
106: data analysis unit,
107: data analysis result display unit,
108: analysis result display unit,
109: database,
110: computer

1. A total integration analysis model assistance device which simultaneously estimates a performance and a manufacturing cost of a mechanical structure to be analyzed, comprising:
means for displaying an analysis process input screen on which an analysis process is displayed by selecting an analysis node having an analysis program;
means for displaying an analysis condition input screen on which an input condition required for the analysis is displayed;
means for creating an analysis model in accordance with the analysis process to analyze a performance estimation, and analyzing the manufacturing cost in accordance with a result of the performance estimation;
means for acquiring past manufacturing cost information;
means for displaying a data analysis condition input screen on which an analysis condition is displayed;
means for grouping the past manufacturing cost information using a clustering method;
means for visualizing a result derived from the unit for grouping as a graph; and
means for acquiring and displaying an analysis result.

2. A total integration analysis model assistance device which simultaneously estimates a performance and a manufacturing cost of a mechanical structure to be analyzed, comprising:
means for displaying an analysis process input screen on which an analysis process is displayed by selecting an analysis node having an analysis program;
means for displaying an analysis condition input screen on which an input condition required for analysis is displayed;
means for creating an analysis model in accordance with the analysis process to analyze a performance estimation, calculating a group corresponding to group information generated in accordance with a result of the performance estimation, and calculating the manufacturing cost in reference to the manufacturing cost data of the corresponding group;
means for acquiring past manufacturing cost information;
means for displaying a data analysis condition input screen on which an analysis condition is displayed by visualizing the past manufacturing cost information as a graph;
means for grouping the past manufacturing cost information using a clustering method;
means for visualizing a result derived from the unit for grouping as a graph; and
means for acquiring and displaying an analysis result.

3. A total integration analysis model assistance device which simultaneously estimates a performance and a manufacturing cost of a mechanical structure to be analyzed, comprising:
means for displaying an analysis process input screen on which an analysis process is displayed by selecting an analysis node containing an analysis program;
means for displaying an analysis condition input screen on which an input condition required for analysis is displayed;
means for creating an analysis model in accordance with the analysis process to analyze a performance estimation, calculating a group corresponding to group information generated in accordance with a result of the performance estimation, and analyzing an arithmetic mean of the manufacturing cost data from manufacturing cost data of the corresponding group as the manufacturing cost;
means for acquiring past manufacturing cost information;
means for displaying a data analysis condition input screen on which the past manufacturing cost information is visualized as a graph, and a variance for grouping is displayed as an analysis condition;
means for grouping the past manufacturing cost information using a k-means clustering method;
means for visualizing a result of the grouping as a graph; and
means for acquiring and displaying an analysis result.
